(19) United States
(12) Patent Application Publication
(10) Pub. No.: US 2014/0072433 A1
(43) Pub. Date: Mar. 13, 2014

(54) METHOD OF CLOCKING A TURBINE BY RESHAPING THE TURBINE'S DOWNSTREAM AIRFOILS

(71) Applicant: Dennis Scott Holloway, Simpsonville, SC (US)

(72) Inventor: Dennis Scott Holloway, Simpsonville, SC (US)

(73) Assignee: General Electric Company, Schenectady, NY (US)

(21) Appl. No.: 13/608,471

(22) Filed: Sep. 10, 2012

(51) Int. Cl. F01D 5/22; B23P 6/00

(52) U.S. Cl. 416/198 R; 29/889.1

(57) ABSTRACT

A method of clocking a turbine is disclosed in which the leading edge of clocked downstream airfoils are bathed by either a low total pressure wake, or a cooled low total temperature wake, or both, by reshaping at least the leading edge of an airfoil along the airfoils' span or radial distance. The improvement is due to the fact that gas turbine wakes tend to be non-linear, such that a straight clocked downstream airfoil will receive a benefit of low total temperature or pressure over a portion of its span, while a restacked airfoil receives a benefit over a greater portion of the airfoil span from turbine hub to casing.

The present invention relates to turbines, and more particularly, to a method of clocking a turbine by reshaping the turbine's downstream airfoils.

### BACKGROUND OF THE INVENTION

The performance of gas turbines can be affected by thermal and pressure gradients. One major source of thermal gradients is the large circumferential and radial temperature non-uniformities (i.e., hot streaks and cooling wakes) in the flow exiting a turbine combustor. Another source of non-uniformity is wakes from upstream airfoils of the same frame of reference. It has been found that controlling the relative circumferential positions of gas turbine blades, known as clocking or indexing, can increase the efficiency of turbine stages and mitigate the effects of combustor hot streaks and upstream airfoil wakes. Thus, clocking of turbine airfoils can provide significant thermal and other performance benefits.

In practice, the clocking of turbine airfoils is essentially a procedure of aligning airfoils of like count and reference frame (i.e., rotor to rotor and stator to stator) without any consideration of the optimal airfoil and wake shapes to get the best possible clocking design.

For airfoils of like count, the relative position of a downstream stator to the wake emanating from an upstream stator can lead to significant swings in turbine efficiency and airfoil, platform and casing temperatures. The same applies to subsequent rotor stages.

An analysis of an upstream stage, for example Stage 1, will produce a time-averaged inlet flow field to the downstream stage. This flow field will contain the upstream stator (or rotor) wake signature for stator-to-stator (or rotor-to-rotor) clocking. Design tools, such as Computational Fluid Dynamics (2D, 3D, steady, unsteady) and 2D streamtube analysis, can be used to reshape or restack the downstream to optimize the clocking for both thermal and aerodynamic performance.

For highly non-linear wakes, as one would see in a low aspect ratio stage 1 of a high pressure turbine (“HPT”), it would be quite obvious that a downstream airfoil has been reshaped to make it more optimized for clocking. However, for higher aspect ratio stages, such as a low pressure turbine (“LPT”), the wakes are straighter over a larger percentage of the span.

For stators of like count, the relative position of a downstream stator to the wake emanating from an upstream stator can lead to significant swings in turbine efficiency and hot gas path (“HGP”) surface temperatures. The same applies to subsequent rotor stages. The improvement is due to the fact that gas turbine wakes tend to be non-linear. A straight downstream airfoil will receive a benefit (i.e., low total temperature and pressure) over a portion of its span. Reshaping or stacking of the airfoil gives potential to a benefit over a greater portion of the span.

It is nearly impossible to completely straighten wakes, particularly for low aspect ratio HPT stages, thus reshaping the downstream airfoil to optimize the thermal and performance benefit has greater potential in many applications. The present invention shows that by reshaping the leading edge of the downstream airfoil the potential hub to span benefit can be increased.

### BRIEF DESCRIPTION OF THE INVENTION

In an exemplary embodiment of the invention, a method of clocking a turbine, in which the turbine is comprised of a plurality of airfoils, the turbine airfoils being comprised of at least a first, upstream row of airfoils in a first frame of reference, a second row of airfoils in the first frame of reference, which are downstream from the first row of airfoils, and a third row of airfoils in a second frame of reference, which are intermediate the first and second rows of airfoils, comprises the steps of changing a circumferential position of the row of downstream airfoils relative to a circumferential position of the row of upstream airfoils so that the downstream airfoils are more within the upstream airfoils' wakes than before the circumferential position of the row of downstream airfoils was changed, for each upstream airfoil's wake, locating at least one portion of the wake corresponding to a lowest temperature in the wake, a lowest pressure in the wake, or a lowest temperature and pressure in the wake, for each upstream airfoil's wake, reshaping the downstream airfoil positioned within the wake so that more of at least the downstream airfoil's leading edge is within the lowest temperature portion of the wake, the lowest pressure portion of the wake or the lowest temperature and pressure portion of the wake than before the downstream airfoil was reshaped.

In another exemplary embodiment of the invention, a method of clocking a turbine, in which the turbine is comprised of a plurality of airfoils, the turbine airfoils being comprised of at least a first, upstream row of airfoils in a first frame of reference, a second row of airfoils in the first frame of reference, which are downstream from the first row of airfoils, and a third row of airfoils in a second frame of reference, which are intermediate the first and second rows of airfoils, each downstream airfoil being formed from a plurality of design sections which are stacked relative to one another, comprising the steps of changing a circumferential position of the row of downstream airfoils relative to a circumferential position of the row of upstream airfoils so that the downstream airfoils are more within the upstream airfoils' wakes than before the circumferential position of the row of downstream airfoils was changed, for each upstream airfoil's wake, locating portions of the wake corresponding to a lowest temperature in the wake, a lowest pressure in the wake, or a lowest temperature and pressure in the wake along the downstream airfoil's span or radial height, for each upstream airfoil's wake, restacking the plurality of design sections forming the downstream airfoil positioned within the wake so that more of the downstream airfoil's leading edge and plurality of design sections are within the lowest temperature portions of the wake, the lowest pressure portions of the wake or the lowest temperature and pressure portions of the wake than before the downstream airfoil was reshaped.

In a further exemplary embodiment of the invention, an clocked turbine comprises a plurality of airfoils, the turbine airfoils being comprised of at least a first, upstream row of airfoils in a first frame of reference, a second row of airfoils in the first frame of reference, which are downstream from the first row of airfoils, each downstream airfoil being formed from a plurality of design sections which are stacked relative to one another, and a third row of airfoils in a second frame of reference, which are intermediate the first and second rows of airfoils, a circumferential position of the row of downstream airfoils having been changed relative to a circumferential position of the row of upstream airfoils so that the downstream airfoils are more within the upstream airfoils' wakes than before the circumferential position of the row of downstream airfoils was changed, each upstream airfoil, in operation, producing a wake including at least one portion corresponding to a lowest temperature in the wake, a lowest pressure in the wake, or a lowest temperature and pressure in the wake, each downstream airfoil within an upstream airfoil's wake being restacked so that the plurality of design sections forming the downstream airfoil cause the downstream airfoil to be positioned within the wake so that more of at least the downstream airfoil's leading edge is within the at least one lowest temperature portion, lowest pressure portion or lowest temperature and pressure portion of the wake than before the downstream airfoil was reshaped.

The present invention allows a benefit (i.e., low total temperature and pressure) to be realized by allowing the leading edge or the entire outer surface of downstream airfoils to be bathed by either a low total pressure wake or a cooled low total temperature wake or both. By reshaping the leading edge of an airfoil, or the entire airfoil along its span or radial distance, the potential benefit from the leading edge or the entire outer surface of the airfoil to be bathed in either a low total pressure wake or a cooled low total temperature wake or both, can be increased. The improvement is due to the fact that gas turbine wakes tend to be non-linear. A straight downstream airfoil will receive a benefit (i.e., low total temperature and pressure) over a portion of its span. Reshaping or stacking of the airfoil gives potential to a benefit over a greater portion of the airfoil span from turbine hub to casing.

### BRIEF DESCRIPTION OF THE DRAWINGS

FIG. 1 is a simplified schematic diagram of a multi-stage gas turbine system.

FIG. 2 is a two dimensional (2D) cross-sectional view of airfoil clocking in a turbo machine, such as a turbine.

FIG. 3 is a partial isometric view of a turbine airfoil showing design sections of the airfoil capable of being restacked relative to one another.

FIG. 4 is a partial isometric view of a typical turbine airfoil, such as a stator or rotor blade.

FIG. 5 is a partial isometric view of the turbine airfoil of FIG. 4 with the design sections of the airfoil restacked.

FIG. 6 is a two-dimensional (2D) cross sectional view of a downstream, clocked turbine airfoil before restacking.

FIG. 7 is a two-dimensional (2D) cross sectional view of the downstream, clocked turbine airfoil of FIG. 6 after restacking.

FIG. 8 is a simplified isometric view of the downstream, clocked turbine airfoil of FIG. 6 before restacking and the wake of an upstream airfoil. This wake can either be the thermal wake (total temperature) or the momentum wake (total pressure).

FIG. 9 is a simplified isometric view of the downstream, clocked turbine airfoil of FIG. 7 after restacking and the wake of an upstream airfoil, wherein the clocked airfoil is reshaped so that the wake, which can be either the thermal wake (total temperature) or the momentum wake (total pressure), is bathing the reshaped airfoil's leading edge.

FIG. 10 is a graph depicting Total Pressure versus Circumferential Position at Downstream Airfoil Leading Edge at a Generic Span (i.e., Momentum Wake).

FIG. 11 is a graph depicting Total Temperature versus Circumferential Position at Downstream Airfoil Leading Edge at a Generic Span (i.e., Thermal Wake).

### DETAILED DESCRIPTION OF THE INVENTION

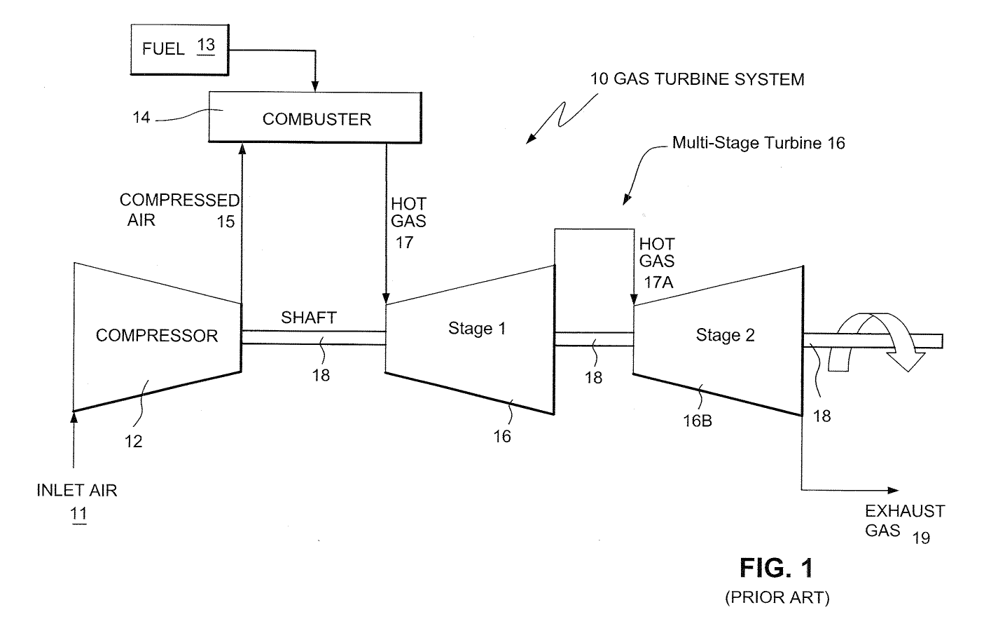

FIG. 1 is a simplified schematic diagram of a multi-stage gas turbine system 10. The gas turbine system 10 shown in FIG. 1 includes a compressor 12, which compresses incoming air 11 to a high pressure, a combustor 14, which burns fuel 13 so as to produce a high-pressure, high-velocity hot gas 17, and a turbine 16, which extracts energy from the high-pressure, high-velocity hot gas 17 entering the turbine 16 from the combustor 14 using turbine blades (not shown in FIG. 1) that are rotated by the hot gas 17 passing through them. As the turbine 16 is rotated, a shaft 18 connected to the turbine 16 is caused to be rotated as well. As shown in FIG. 1, turbine 16 is a multi-stage turbine with the first and second stages shown and designated as 16A and 16B, respectively. To maximize turbine efficiency, the hot gas 17/17A is expanded (and thereby reduced in pressure) as it flows from the first stage 16A of turbine 16 to the second stage 16B of turbine 16, generating work in the different stages of turbine 16 as the hot gas 17 passes through. In a gas turbine engine, a single turbine section is made up of either a disk that holds many turbine stator blades or a rotating hub that holds many turbine rotor blades. The turbine blades are responsible for extracting energy from the high temperature, high pressure gas produced by the combustor that flows through the turbine blades. Eventually, exhaust gas 19 exits the last stage of turbine 16, which is shown in FIG. 1 as the second stage 16B.

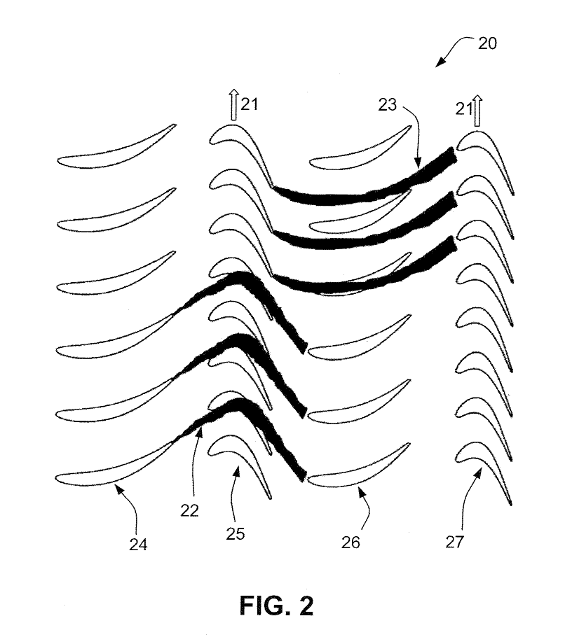

FIG. 2 is a two dimensional (2D) cross-sectional view 20 of “airfoil clocking” in a turbo-machine, such as a turbine 16. Turbo-machinery airfoil clocking involves three blade rows. Two blade rows are in the same frame of reference; that is, two blade rows are both either stators or rotors. One of the two blade rows is an upstream airfoil. The other of the two blade rows is a downstream airfoil. The third blade row, which is intermediate the two blade rows, rotates relative to the other two blade rows. The downstream airfoil is “clocked”, i.e., circumferentially positioned, relative to the wake of the upstream airfoil.

The clocked airfoil count needs to be an integral multiple of the upstream blade row, such that typically a ratio of 1:1 would be used. But, it should be noted that other ratios, such as 2:1, etc., could also be used, because they could see some benefit, as well, to the clocking of downstream airfoils relative to upstream airfoils.

FIG. 2 shows a series of turbine rotors and stators, which include an upstream stator 24, an upstream rotor 25, a downstream, clocked stator 26 and a downstream, clocked rotor 27. The upstream rotor 25 and the downstream, clocked rotor 27 are each rotating in a direction indicated by an arrow 21. The upstream stator 24 produces a wake 22. Similarly, the upstream rotor 25 produces a wake 23. The downstream airfoil, i.e., downstream stator 26 is clocked relative to the upstream stator 24. The downstream airfoil, i.e., rotor 27, is clocked relative to the upstream rotor 25.

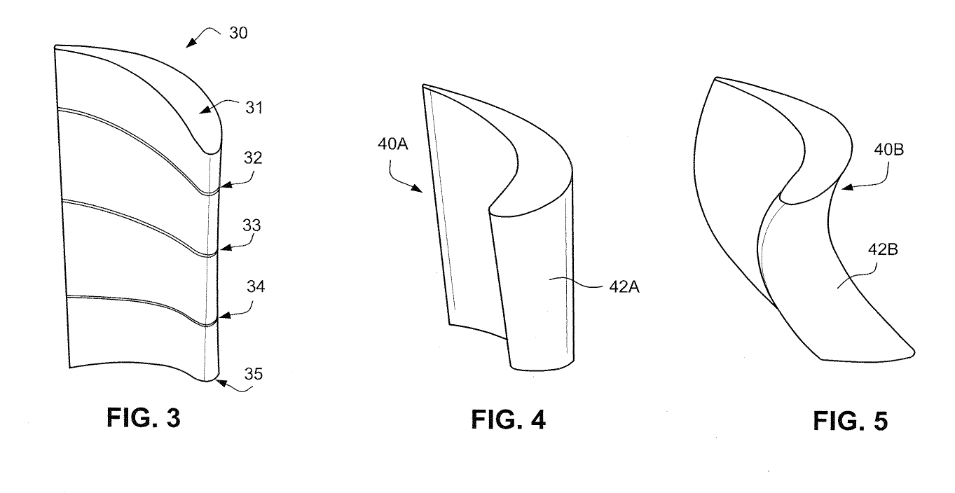

FIG. 3 is a partial perspective, elevational view of a three dimensional (3D) turbine airfoil 30 showing design sections 31-35 of the airfoil 30 capable of being restacked relative to one another. A three-dimensional airfoil, such as airfoil 30, is created by “stacking” design sections relative to one another, both circumferentially and/or axially. Airfoil 30 includes, as shown in FIG. 3, an outer diameter design section 31, an 80% radial span design section 32, a 50% radial span design section 33, a 20% radial span design section 34, and an inner diameter or hub design section 35. The relative stacking of these design sections can produce different shaped airfoils.

FIG. 4 is a partial perspective, elevational view of one example of a turbine airfoil 40A, such as a rotor or stator blade, in which the design sections have not been restacked. Turbine airfoil 40A includes a leading edge 42A. In contrast, FIG. 5 is a partial perspective view of one example of a turbine airfoil 40B, which is the turbine airfoil 40A in which the design sections have been restacked. Turbine airfoil 40B includes a reshaped leading edge 42B.

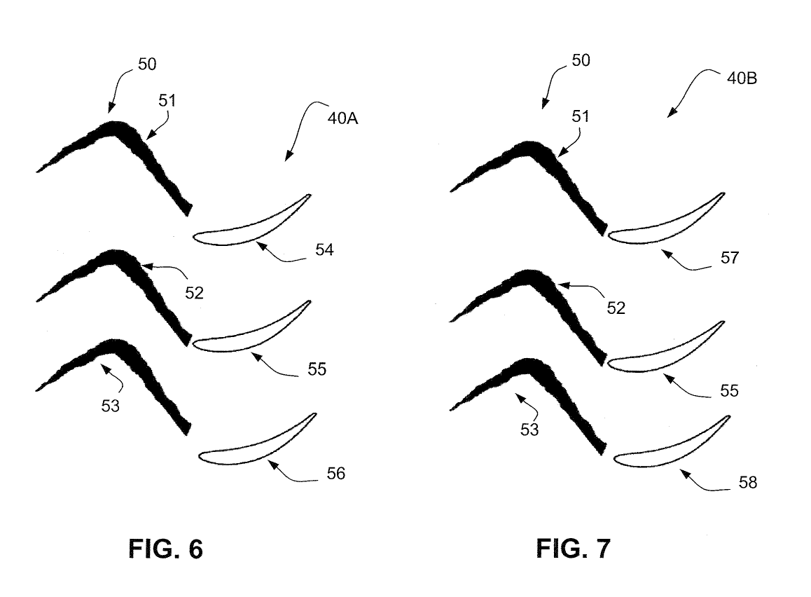

FIG. 6 is a two-dimensional (2D) cross sectional view of a downstream, clocked turbine airfoil 40A before restacking, while FIG. 7 is a two-dimensional (2D) cross sectional view of the downstream, clocked turbine airfoil 40B after restacking. FIG. 6 shows the downstream, clocked turbine airfoil 40A before restacking as including an 80% radial span design section 54, a 50% radial span design section 55 and a 20% radial span design section 56. FIG. 7 shows the downstream, clocked turbine airfoil 40B after restacking as including an 80% radial span design section 57, the 50% radial span design section 55 and a 20% radial span design section 58.

The 80% radial span design section 54 is shown in FIG. 6 as being near a portion 51 of an upstream airfoil wake 50. Likewise, the 50% radial span design section 55 is shown in FIG. 6 as being near a portion 52 of the upstream airfoil wake 50. Finally, the 20% radial span design section 56 is shown in FIG. 6 as being near a portion 53 of the upstream airfoil wake 50.

FIGS. 5A and 5B are intended to depict differences that occur in airfoil 40A when it is restacked as airfoil 40B. In essence, FIGS. 5A and 5B show tangential restacking of the 80% radial span design section 54 and the 20% radial span design section 56 of the downstream airfoil 40A, although it should be noted that airfoil 40A could be restacked both circumferentially and/or axially. The 80% radial span design section and the 20% radial span design section of airfoil 40A are shown in FIG. 7 as being shifted, in airfoil 40B, to be placed in line of the wake portions 51 and 53, respectively. Here, the restacked 80% radial span design section and the restacked 20% radial span design section are designated with the references numeral 57 and 58, respectively, to show the outer and inner design sections as being shifted to be placed in line with the upstream airfoil wake portions 51 and 53.

FIGS. 5A and 5B also show the 50% radial span design section 55 of the downstream airfoil 40A as not being restacked because the leading edge of section 55 already is already in line with the upstream airfoil wake portion 52. The result of what is depicted in FIGS. 5A and 5B generally corresponds to the airfoils 40A and 40B, respectively, depicted in FIGS. 4A and 4B.

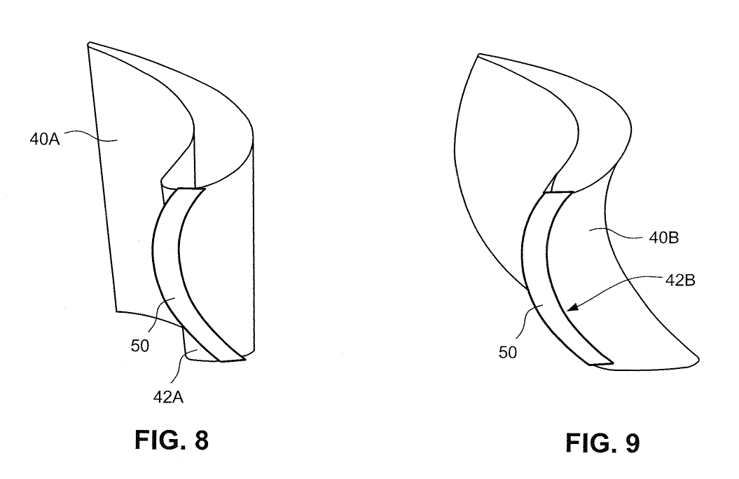

FIG. 8 is a simplified isometric of a downstream, clocked turbine airfoil 40A like the airfoil 40A of FIG. 4, before restacking, showing a wake 50 of an upstream airfoil bathing the downstream airfoil 50A in its best clocking position. This wake 50 can either be the thermal wake (total temperature) or the momentum wake (total pressure).

For the restacked stacked airfoil 40B shown in FIG. 9 in the best clocking position, the leading edge 42B of the airfoil 40B is bathed more by the wake 50 due to the upstream airfoil along the entire radial height of airfoil 40B than is the leading edge 42A of the airfoil 40A before restacking.

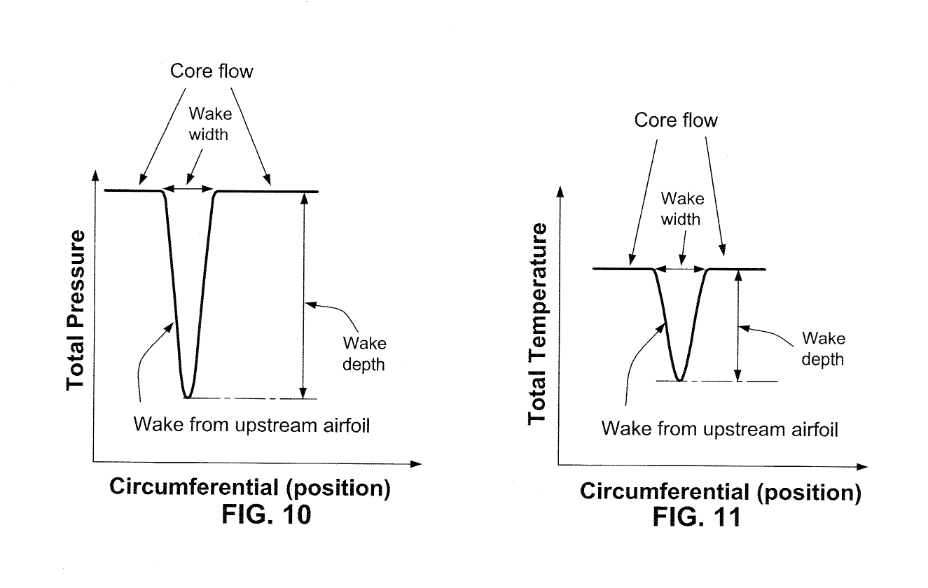

FIG. 10 shows the total pressure as a function of circumferential position at a selected one of the leading edge sections 54, 55 or 56 of the downstream airfoil 40A at a specific radial height or span corresponding to the selected one (54, 55 or 56) of the leading edge portions. The wake due to the upstream airfoil is represented by the low total pressure region.

FIG. 11 shows the total temperature as a function of circumferential position at one of the leading edge sections 57, 55 or 58 of the downstream airfoil 40E at a specific radial height or span corresponding to the selected one (57, 55 or 58) of the leading edge portions. The thermal wake due to the upstream airfoil is represented by the low total temperature region.

The criteria used to decide how to restack downstream airfoils would include an area of low total pressure or low total temperature in the wake of the upstream airfoil corresponding to a given downstream airfoil. A one-dimensional plot of pressure or temperature versus circumferential position (theta) along a given downstream airfoil's span or radial height would result in a series of low spots (deficits) or valleys corresponding to several portions of the wake of the upstream airfoil at the several leading edge sections of the airfoil. These wake “valleys” would have some width. Each valley width would correspond, for example, to the left to right distance of one of the portions of an upstream airfoil wake, such as the portions 51, 52 or 53 of the upstream airfoil wake 50. Ideally, the restacking of the downstream airfoil leading edge portions, such as the leading edge sections 57, 55 or 58 of the downstream airfoil 40B, would correspond to the bottom spots (i.e., the lowest temperatures or the lowest pressures), recognizing that there would be some margin of adjustment in the restacking of the downstream airfoil. The result would be a restacked airfoil, like airfoil 40B, that was aligned using a criteria of the lowest temperature or the lowest pressure at each of the leading edge sections of the airfoil, plus some percentage of the pitch, that is, the circumferential distance between two airfoils.

An example of how this can be done as shown in FIG. 10, which shows the total pressure as a function of circumferential position at one of the leading edge sections along the radial height or span of a downstream airfoil. The location of minimum total pressure is the momentum wake. To restack the downstream airfoil, the design section at this point of the radial height or span would be shifted to be aligned with the location of the minimum total pressure. This could also apply for the thermal wake by evaluating total temperature instead of total pressure. This is shown in FIG. 7B. It should be noted that, for a given airfoil, it is possible that there could be several graphs like those of FIG. 7A or 7B corresponding to the several leading edge sections of the airfoil.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of clocking a turbine, the turbine being comprised of a plurality of airfoils, the turbine airfoils being comprised of at least a first, upstream row of airfoils in a first frame of reference, a second row of airfoils in the first frame of reference, which are downstream from the first row of airfoils, and a third row of airfoils in a second frame of reference, which are intermediate the first and second rows of airfoils, the method comprising the steps of:
changing a circumferential position of the row of downstream airfoils relative to a circumferential position of the row of upstream airfoils so that the downstream airfoils are more within the upstream airfoils' wakes than before the circumferential position of the row of downstream airfoils was changed,
for each upstream airfoil's wake, locating at least one portion of the wake corresponding to a lowest temperature in the wake, a lowest pressure in the wake, or a lowest temperature and pressure in the wake,
for each upstream airfoil's wake, reshaping the downstream airfoil positioned within the wake so that more of at least the downstream airfoil's leading edge is within the lowest temperature portion of the wake, the lowest pressure portion of the wake or the lowest temperature and pressure portion of the wake than before the downstream airfoil was reshaped.

2. The method of claim 1, wherein circumferential positioning of the at least one portion of the upstream airfoil's wake corresponding to the lowest temperature in the wake, the lowest pressure in the wake or the lowest temperature and pressure in the wake is located using a plot of lowest pressure, lowest temperature or lowest pressure and lowest temperature measured over the downstream airfoil's radial length.

3. The method of claim 2, wherein the at least one portion of the upstream airfoil's wake corresponding to the lowest temperature, the lowest pressure or the lowest temperature and the lowest pressure in the wake has a circumferential width, and wherein at least a part of the surface of the downstream airfoil positioned within the portion of the wake corresponding to the lowest temperature, the lowest pressure or the lowest temperature and the lowest pressure in the wake is located within the circumferential width of the wake portion.

4. The method of claim 1, wherein each downstream airfoil is formed from a plurality of design sections which are stacked relative to one another.

5. The method of claim 4, wherein each downstream airfoil is reshaped by restacking the plurality of design sections forming the downstream airfoil relative to one another, either circumferentially, axially or circumferentially and axially.

6. The method of claim 1, wherein each downstream airfoil is reshaped into a bow shape.

7. The method of claim 5, wherein for each upstream airfoil's wake, portions of the wake corresponding to a lowest temperature in the wake, a lowest pressure in the wake, or a lowest temperature and pressure in the wake along the downstream airfoil's span or radial height are located, and wherein each downstream airfoil is reshaped by restacking the plurality of design sections forming the downstream airfoil relative to one another so that more of at least the downstream airfoil's leading edge is within the lowest temperature portions of the wake, the lowest pressure portions of the wake or the lowest temperature and pressure portions of the wake than before the downstream airfoil was reshaped.

8. The method of claim 4, wherein the plurality of design sections includes an outer diameter design section, an 80% radial span design section, a 50% radial span design section, a 20% radial span design section, and an inner diameter design section.

9. The method of claim 1, wherein, for each upstream airfoil's wake, the downstream airfoil positioned within the wake is reshaped so that more of the downstream airfoil's surface is within the lowest temperature portion of the wake, the lowest pressure portion of the wake or the lowest temperature and pressure portion of the wake than before the downstream airfoil was reshaped.

10. The method of claim 1, wherein the upstream and downstream rows of airfoils are both either stators or rotors and the intermediate row of airfoils is a rotor, if the upstream and downstream rows of airfoils are both stators, or is a stator, if the upstream and downstream rows of airfoils are both rotors.

11. The method of claim 1, wherein the upstream and downstream rows of airfoils together and the intermediate row of airfoils are rotating relative to each other.

12. A method of clocking a turbine, the turbine being comprised of a plurality of airfoils, the turbine airfoils being comprised of at least a first, upstream row of airfoils in a first frame of reference, a second row of airfoils in the first frame of reference, which are downstream from the first row of airfoils, and a third row of airfoils in a second frame of reference, which are intermediate the first and second rows of airfoils, each downstream airfoil being formed from a plurality of design sections which are stacked relative to one another, the method comprising the steps of:
changing a circumferential position of the row of downstream airfoils relative to a circumferential position of the row of upstream airfoils so that the downstream airfoils are more within the upstream airfoils' wakes than before the circumferential position of the row of downstream airfoils was changed,
for each upstream airfoil's wake, locating portions of the wake corresponding to a lowest temperature in the wake, a lowest pressure in the wake, or a lowest temperature and pressure in the wake along the downstream airfoil's span or radial height,
for each upstream airfoil's wake, restacking the plurality of design sections forming the downstream airfoil positioned within the wake so that more of the downstream airfoil's leading edge or the entire outer surface of the downstream airfoil is within the lowest temperature portions of the wake, the lowest pressure portions of the wake or the lowest temperature and pressure portions of the wake than before the downstream airfoil was reshaped.

13. The method of claim 12, wherein the design sections forming the downstream airfoil positioned within the wake are reshaped by restacking the plurality of design sections relative to one another, either circumferentially, axially or circumferentially and axially.

14. The method of claim 13, wherein the portions of the upstream airfoil's wake corresponding to the lowest temperature in the wake, the lowest pressure in the wake or the lowest temperature and pressure in the wake are circumferentially plotted over the downstream airfoil's radial length to ascertain the circumferential location of the wake portion.

15. An clocked turbine comprising:
a plurality of airfoils, the turbine airfoils being comprised of at least:
a first, upstream row of airfoils in a first frame of reference,
a second row of airfoils in the first frame of reference, which are downstream from the first row of airfoils, each downstream airfoil being formed from a plurality of design sections which are stacked relative to one another, and
a third row of airfoils in a second frame of reference, which are intermediate the first and second rows of airfoils,
a circumferential position of the row of downstream airfoils having been changed relative to a circumferential position of the row of upstream airfoils so that the downstream airfoils are more within the upstream airfoils' wakes than before the circumferential position of the row of downstream airfoils was changed,
each upstream airfoil, in operation, producing a wake including at least one portion corresponding to a lowest temperature in the wake, a lowest pressure in the wake, or a lowest temperature and pressure in the wake,
each downstream airfoil within an upstream airfoil's wake being restacked so that the plurality of design sections forming the downstream airfoil cause the downstream airfoil to be positioned within the wake so that more of at least the downstream airfoil's leading edge is within the at least one lowest temperature portion, lowest pressure portion or lowest temperature and pressure portion of the wake than before the downstream airfoil was reshaped.

16. The turbine of claim 15, wherein each downstream airfoil is reshaped by restacking the plurality of design sections forming the downstream airfoil relative to one another, either circumferentially, axially or circumferentially and axially.

17. The turbine of claim 15, wherein each downstream airfoil is reshaped into a bow shape the downstream airfoil's entire outer surface is within the at least one lowest temperature portion, lowest pressure portion or lowest temperature and pressure portion of the wake than before the downstream airfoil was reshaped.

18. The turbine of claim 15, wherein the downstream airfoil's leading edge and plurality of design sections are within the at least one lowest temperature portion, the lowest pressure portion or the lowest temperature and pressure portion of the wake.

19. The turbine of claim 15, wherein the plurality of design sections includes an outer diameter design section, an 80% radial span design section, a 50% radial span design section, a 20% radial span design section, and an inner diameter design section.

20. The turbine of claim 15, wherein each downstream airfoil within an upstream airfoil's wake is restacked so that the plurality of design sections forming the downstream airfoil cause the downstream airfoil to be positioned within the wake so that more of the downstream airfoil's outer surface is within the lowest temperature portion of the wake, the lowest pressure portion of the wake or the lowest temperature and pressure portion of the wake than before the downstream airfoil was reshaped.
